(19) United States
(12) Patent Application Publication
(10) Pub. No.: US 2016/0310993 A1
(43) Pub. Date: Oct. 27, 2016

(54) Mobile Mechanical Xeriscape Gravel Cleaner

(71) Applicant: Thomas R. Hill, Rio Rancho, NM (US)

(72) Inventor: Thomas R. Hill, Rio Rancho, NM (US)

(21) Appl. No.: 14/694,842

(22) Filed: Apr. 23, 2015

(51) Int. Cl. B07B 1/00; B07B 1/24

(52) U.S. Cl. CPC B07B 1/005; B07B 1/24

(57) ABSTRACT

Disclosed is mobile mechanical xeriscape gravel cleaner which is delivered to the site of the xeriscaping to be cleaned by a wheel/axle assembly, leveled with adjustable jack stands mounted on the metal frame. Xeriscape material to be cleaned is collected and deposited in a hopper with slide plate to control flow of material into the receiving chamber. Using an external power system, the auger/screener device rotation begins and picks up and carries forward the material, passing through the transition plate to the auger/cleaner chamber where foreign material passes through the screen. The cleaned material proceeds to the discharge chamber where it is collected and returned to the original xeriscaped site. The mobile mechanical xeriscape gravel cleaner can clean xeriscape gravel at a lower cost, with improved quality and a higher rate of speed than was previously possible, with significantly reduced burden to the ecosystem.

### CROSS REFERENCE TO RELATED APPLICATIONS

This application is a Continuation in Part of application Ser. No. 13/757,751 filed Feb. 2, 2013 of Thomas R. Hill for a MOBILE MECHANICAL XERISCAPE GRAVEL CLEANER.

### STATEMENT REGARDING FEDERALLY SPONSORED R&D

None.

### NAMES OF PARTIES TO A JOINT RESEARCH AGREEMENT

None.

### BACKGROUND OF THE INVENTION

1. Field of the Invention

The present invention relates to the cleaning of xeriscape gravel utilizing a mobile mechanical cleaner to allow for an on-site process. It is a rotating auger screen assembly powered by a variable speed external power driven motor or engine, hydraulic and/or gear, chain and sprocket system. If hydraulics are utilized the motor or engine will additionally provide activation of a hydraulic jack leveling system, a hydraulic movable hopper to allow for lower loading positions and hydraulic operation of the wheel/axle assembly to manage mobility of the entire cleaner device from the control panel. Xeriscape gravel is collected from the site and loaded into a hopper which feeds it into a receiving chamber where it is picked up by the rotating auger screen assembly and feed through the cleaning chamber where dirt and debris fall through the screen for disposal and on to the discharge chamber where the cleaned xeriscape gravel is collected and returned to the site. The entire device can be sized to facilitate accessing most areas of residential and commercial properties without difficulty and screen can be easily changed to accommodate cleaning of varied sizes of xeriscape gravel by releasing the screen clamps.

2. Description of the Prior Art

Previous efforts to clean xeriscape gravel has been labor intensive and marginally effective either using a handheld shaker screen box cleaning very small quantities or using a front end loader device and dumping the xeriscape onto a larger screen to allow some of the dirt and debris to filter through. Both systems have only partially cleaned the gravel in a single process. Currently, xeriscape gravel is not often commercially cleaned due to the time required, the quality of cleaning and the labor costs associated. Rather the gravel is collected and hauled to a landfill and the property owner buys new gravel to replace it at significant cost.

U.S. Pat. No. 5,054,506; Name of Patentee—Shakeri; Date of Patent—Oct. 8, 1991: A rock and gravel cleaner is disclosed. The rock and gravel cleaner includes a tank having a frame, a water heater connected to the tank, a motor containing an idler pulley arrangement and a fan belt, and a revolving cylinder having a reel at each end revolves via the energy transported from the motor to the reel by the fan belt so that the cylinder revolves on the frame.

This device is intended to extract oil and other pollutants utilizing hot water spray into a hollow screened tube and collecting said extraction for recycling of the oil rather than for the purpose of cleaning the gravel or rock for recycling. This is not a mobile device and would not be appropriate for the cleaning of commercial or residential xeriscape gravel.

### SUMMARY OF THE INVENTION

The mobile mechanical xeriscape gravel cleaner is a mobile machine which can be taken to a property with xeriscape gravel, clean and replace the existing gravel faster, cleaner and more economically than previously methods. Further, it is environmentally friendly in that uncleaned gravel is not going to a landfill and the cleaned xeriscape gravel reduces soil erosion and deters the growth of weeds on the property. Due to drought conditions, particularly in the southwestern states, many communities are requiring a percentage of all urban properties to be xeriscaped to reduce water consumption. It is a rotating auger screen assembly powered by a variable speed external power driven motor or engine, hydraulic and/or gear, chain and sprocket system. If hydraulics are utilized the motor or engine will additionally provide activation of a hydraulic jack leveling system, a hydraulic movable hopper to allow for lower loading positions and hydraulic operation of the wheel/axle assembly to manage mobility of the entire cleaner device from the control panel. Xeriscape gravel is collected from the site and loaded into a hopper which feeds it into a receiving chamber where it is picked up by the rotating auger screen assembly and fed through the cleaning chamber on to the discharge chamber where the cleaned xeriscape gravel is collected and returned to the site. The entire device can be sized to facilitate accessing most areas of residential and commercial properties without difficulty and screen can be easily changed to accommodate cleaning of varied sizes of xeriscape gravel by releasing the screen clamps.

### BRIEF DESCRIPTION OF DRAWINGS

FIG. 1A is the auger with end shafts, auger support bar plates, auger support bars, and screen support bands.

FIG. 1B is the screen support bar.

FIG. 1C is the screen support bands and screen.

FIG. 1D is the end view of the auger support plates to be applied to the end shaft at the end of the discharge chamber.

FIG. 1E is the end view of the auger flights notched to receive the auger support bars.

FIG. 2A is an isometric view of the welded metal frame to receive the auger assembly.

FIG. 2B is an isometric view of the drilled end plate to be mounted to the end of the discharge chamber and the front of the cylindrical material.

FIG. 2C is an isometric view of the transition plate with mounting tabs for cylindrical material and mounting angle support braces which will be mounted at the end of the receiving chamber and the front of the cleaning chamber.

FIG. 3A is a top view of the welded metal frame, auger assembly, lubricated bearings, adjustable roller wheel assembly, the receiving chamber, cleaning chamber and discharge chamber and the cylindrical material of the receiving chamber.

FIG. 4A is an enlarged end view of the adjustable roller wheel assembly detail.

FIG. 4B is an enlarged side view of the adjustable roller wheel assembly detail.

FIG. 5A is a top view of the slide gate hopper assembly without the hopper.

FIG. 5B is an end view of the slide gate hopper assembly including the hopper.

FIG. 6A is an end view of the first step in the slide gate hopper assembly.

FIG. 6B is a top view of the first step in the slide gate hopper assembly.

FIG. 6C is the end view of the second step in the slide gate hopper assembly.

FIG. 6D is the top view of the second step in the slide gate hopper assembly.

FIG. 6E is the end view of the third step in the slide gate hopper assembly.

FIG. 6F is the top view of the third step in the slide gate hopper assembly.

FIG. 7A is the side view of the welded metal frame including the auger assembly and cylindrical material, divided into receiving, cleaning and discharge chambers with location of the variable speed external power drive and chain and sprocket drive, control panel and hopper.

FIG. 7B is the cover plates to be fastened and hinged to the top of the welded metal frame and the engine mounting plate to be fastened to the welded metal frame.

FIG. 7C is the side panels to be applied to the lateral sides of the welded metal frame.

FIG. 8A is an end view of the adjustable independent support jack.

FIG. 8B is a side view of the adjustable independent axle with wheel and flotation tire.

FIG. 8C is a side view of the adjustable independent axle with wheel and flotation tire.

FIG. 9A is the side view of the application of a square receiver tubing to accept a common receiver hitch.

FIG. 9B is an end view of the square receiver tubing to accept a common receiver hitch.

FIG. 10A is a side view of the auger with end shafts auger support plates, auger support bars and screen support bands of the hydraulic design mobile mechanical gravel cleaner according to the present invention.

FIG. 10B is the screen support bar of the hydraulic design mobile mechanical gravel cleaner according to the present invention.

FIG. 10C is the rolled screen of the hydraulic design mobile mechanical gravel cleaner according to the present invention.

FIG. 11A is an isometric view of the welded metal frame to receive the auger assembly of the hydraulic design mobile mechanical gravel cleaner according to the present invention.

FIG. 11B is an isometric view of the drilled end plate to be mounted to the end of the discharge chamber of the hydraulic design mobile mechanical gravel cleaner according to the present invention.

FIG. 11C is an isometric view of the drilled end plate to be mounted to the end of the beginning of the receiving chamber of the hydraulic design mobile mechanical gravel cleaner according to the present invention.

FIG. 12A is a top view of the welded metal frame, auger assembly including the metal screws and shoulder washers attaching the screen, lubricated bearings, adjustable roller wheel assembly, the extended metal frame to accommodate the hydraulic reservoir and hydraulic motor pump assembly, the receiving chamber, cleaning chamber and discharge chamber of the hydraulic design mobile mechanical gravel cleaner according to the present invention.

FIG. 13A is a top view of the gravity flow shoot with the shaft guard and the extended auger shaft in the receiving chamber of the hydraulic design mobile mechanical gravel cleaner according to the present invention.

FIG. 13B is an end view of the transition plate from cleaning chamber side with the gravity flow shoot and shaft guard of the hydraulic design mobile mechanical gravel cleaner according to the present invention.

FIG. 13C is a side view of the transition plate and the gravity flow shoot and extended auger shaft in the receiving chamber of the hydraulic design mobile mechanical gravel cleaner according to the present invention.

FIG. 13D is an end view of the transition plate from the receiving chamber side of the hydraulic design mobile mechanical gravel cleaner according to the present invention.

FIG. 13E is a bottom view of the transition plate, the gravity flow shoot and extended auger shaft in the receiving chamber of the hydraulic design mobile mechanical gravel cleaner according to the present invention.

FIG. 14A is a side view of the extended welded metal frame including the auger assembly divided into receiving, cleaning and discharge chambers with the extended area to accommodate the hydraulic reservoir and hydraulic motor pump assembly, the hydraulically powered drag chain and hopper assembly and the control panel of the hydraulic design mobile mechanical gravel cleaner according to the present invention.

FIG. 14B is the cover plate to be bolted to the extended welded metal frame over the discharge chamber of the hydraulic design mobile mechanical gravel cleaner according to the present invention.

FIG. 14C is the side panels to be applied to the lateral sides of the extended welded metal frame enclosing the receiving chamber, cleaning chamber and discharge chamber of the hydraulic design mobile mechanical gravel cleaner according to the present invention.

### DETAILED DESCRIPTION OF THE INVENTION

1. Best Mode of Invention

Drawings 1/9 through 9/9 show the best mode contemplated by the inventor of the mobile mechanical xeriscape gravel cleaner according to the concepts of the present invention.

2. How to Make the Invention

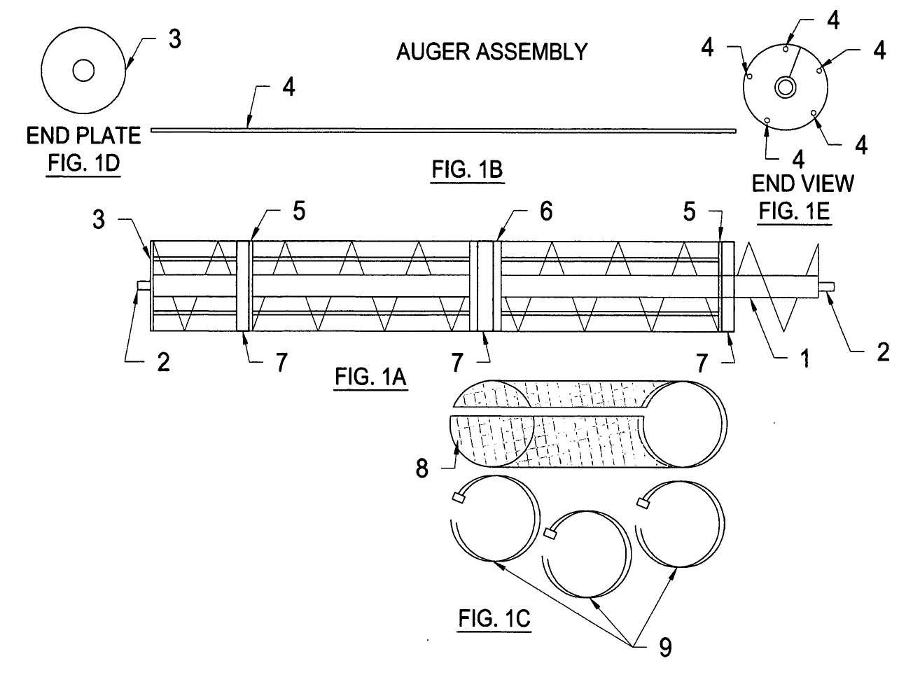

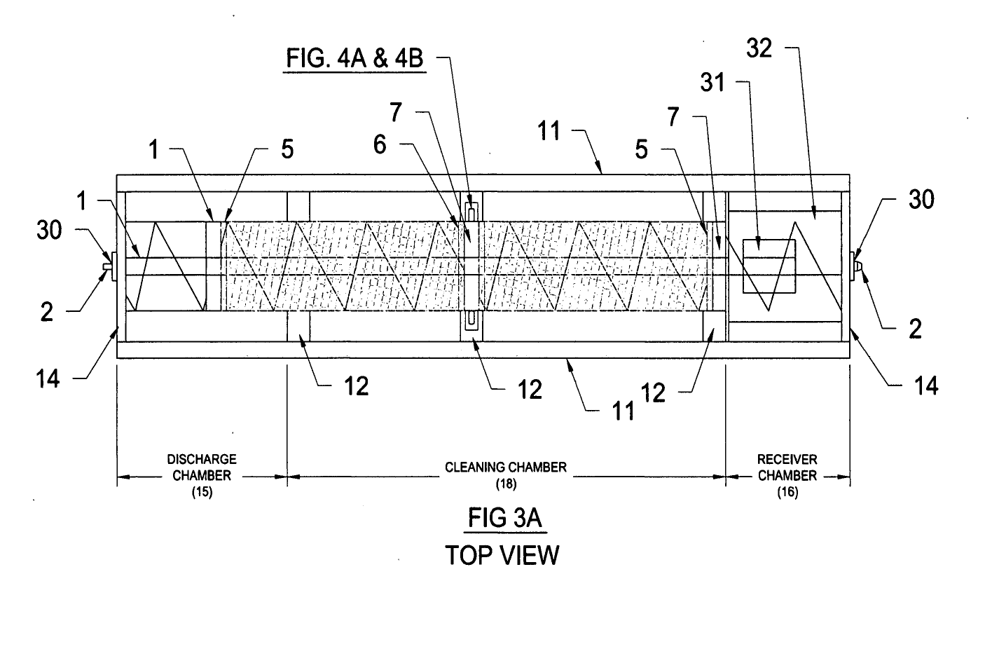

As can be amply seen from the FIG. 1A to 1E of the mobile mechanical xeriscape gravel cleaner auger 1 is a single or double flight design to move landscape gravel to be cleaned through its entire length and equipped and bolted to auger end shaft 2 which will be inserted into the lubricated bearings 30 (FIG. 3A) located and mounted on the auger support bar plate 3 (FIG. 1D). The auger flights are notched equal distance around its circumference to accept the auger support bars 4 (FIG. 1B) along its length from the front of the cleaning chamber to the end of the discharge chamber and then welded in place (FIG. 1E). The auger support bar plate 3 (FIG. 1D) is then mounted on the end of auger tube at the end discharge chamber and welded to the tube, flighting and support bars. The screen support bands 5 are then welded to the front of the cleaning chamber and the end of the cleaning chamber and screen support 6 is welded midway in the cleaning chamber. The screen support bands 7 are welded on top of the previously placed screen support bands 5 and 6, flush with the outer edge of screen support bands 5 and centered on screen support band 6. Two sections of screen 8 (FIG. 1C) are rolled and mounted on the outside of the auger 1 overlapping the inner screen support bands 5 and 6 and secured with clamping bands 9. The screen 8 grid size is determined by the size of the material to be cleaned.

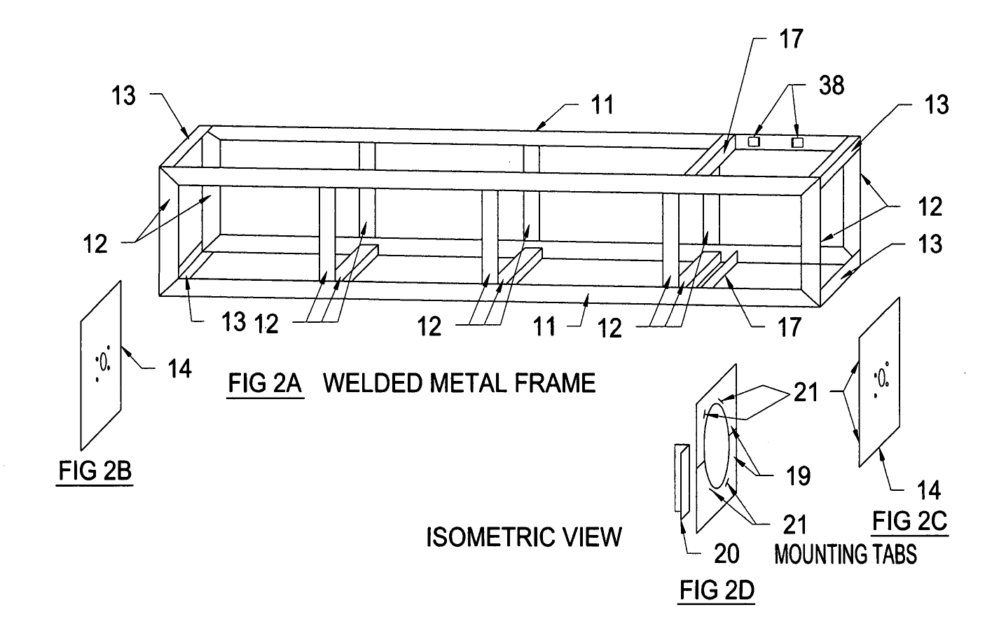

As can be amply seen from FIG. 2A to 2D, an isometric view, and FIG. 3A, a top view of the mobile mechanical xeriscape gravel cleaner a welded metal frame 10 consists of rectangular tubing 11 with vertical and horizontal supports 12 spaced equally along its distance of sufficient length to accommodate auger assembly. Both end structures are surfaced with angle iron 13 to mount end plates 14. The end plates 14 serve as the mounting structure for the lubricating bearings 30 and dimensions of end plates 14 are determined by the height and width of the welded metal frame 10. The end plates 14 are drilled to receive the lubricated bearings 30 (FIG. 3A) which are then bolted in place. The discharge chamber end plate 14 is then bolted to the ends of the welded metal frame 10 with the lubricated bearing 30 (FIG. 3A) facing out. Locate the discharge chamber 15 end of the auger 1 and insert it first into the receiving chamber 16 end of the welded metal frame 10 and slide the entire auger 1 toward the discharge end of the welded metal frame 10 and insert the end shaft 2 of the auger into the lubricated bearing 30 on the discharge chamber 15 end of the welded metal frame. Insert the receiving chamber 16 end shaft 2 into the lubricated bearing 30 on the end plate 2 and bolt into place on the end of the welded metal frame 10 and check to see auger 1 rotates freely. Angle braces 17 are welded to the welded metal frame 10 flush with the top and bottom at the end of the receiving chamber 16 before the cleaning chamber 18 to facilitate mounting of a split transition plate 19. The split transition plate 19 size is determined by the dimensions of the welded metal frame 10 and the size of auger 1 used. The split transition plate 19 is cut horizontally at its vertical midline and bolted to the aforementioned angle braces 17. Additional support angle braces 20 are bolted vertically to each half of the split transition plate 19 on the receiving chamber 16 side of the plate. A section of cylindrical material 32 of sufficient diameter to accommodate the rotation of the auger 1 assembly is placed in the receiving chamber 16, flush with the split transition plate 19 and the end plate 14 of the receiving chamber 16. A rectangular section 31 is cutout of the top of the cylindrical material 32 sufficient to receive material to be cleaned from the hopper 34. Mounting tabs 21 for the cylindrical material 32 are first welded to the receiving chamber 16 end plate 14 and the receiving chamber 16 side of the split transition plate 19 at intervals and bolted to the cylindrical material 32. (FIG. 3A) is a top view including the welded metal frame 10, the receiving chamber 16 (including the cylindrical material 32), cleaning and discharge chambers 18 and 15 and the auger screen assembly.

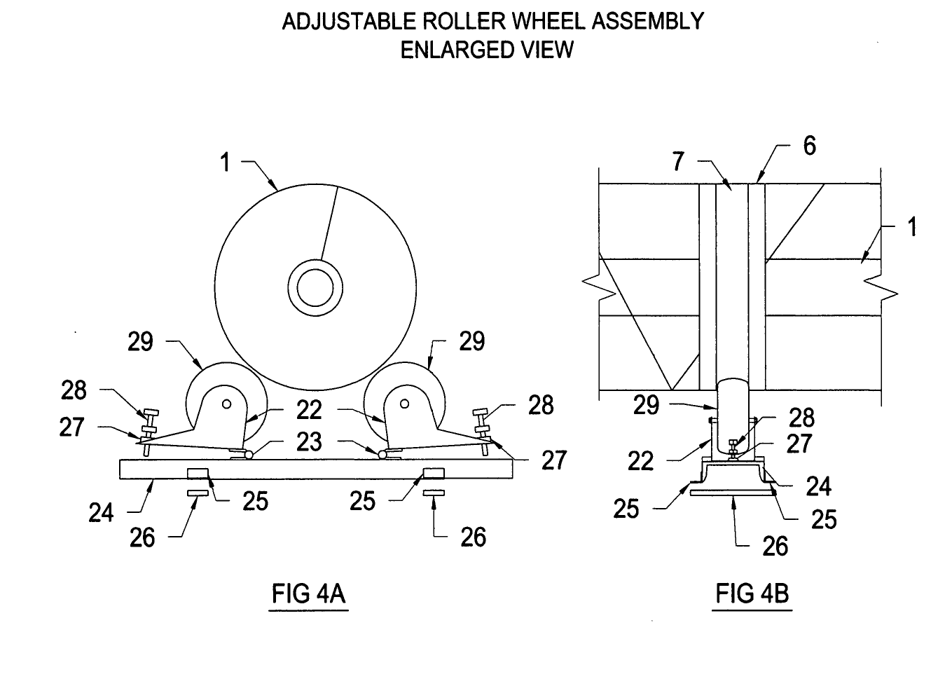

As can be amply seen from the FIG. 4A and 4B of the mobile mechanical xeriscape gravel cleaner, two adjustable roller wheel assemblies are required, each composed of a bracket 22 with a hole to allow attachment to the wheel 29. A hinge 23 is welded to the bracket 22 at the inside edge of the bracket 22, welded to a channel iron 24 and placed over the middle horizontal support 12 (FIG. 2A). Angle iron tabs 25 are welded to the outer edge of the channel iron 24 with a flat bar underneath the horizontal support 12 (FIG. 2A) located at midpoint of the welded metal frame 10. A nut 27 is welded to the outer edge of the bracket 22. A bolt and locking nut 28 is placed in the nut 27 to facilitate adjustment of the adjustable roller wheel assemblies to support the middle auger support band 7 on both sides of the auger assembly.

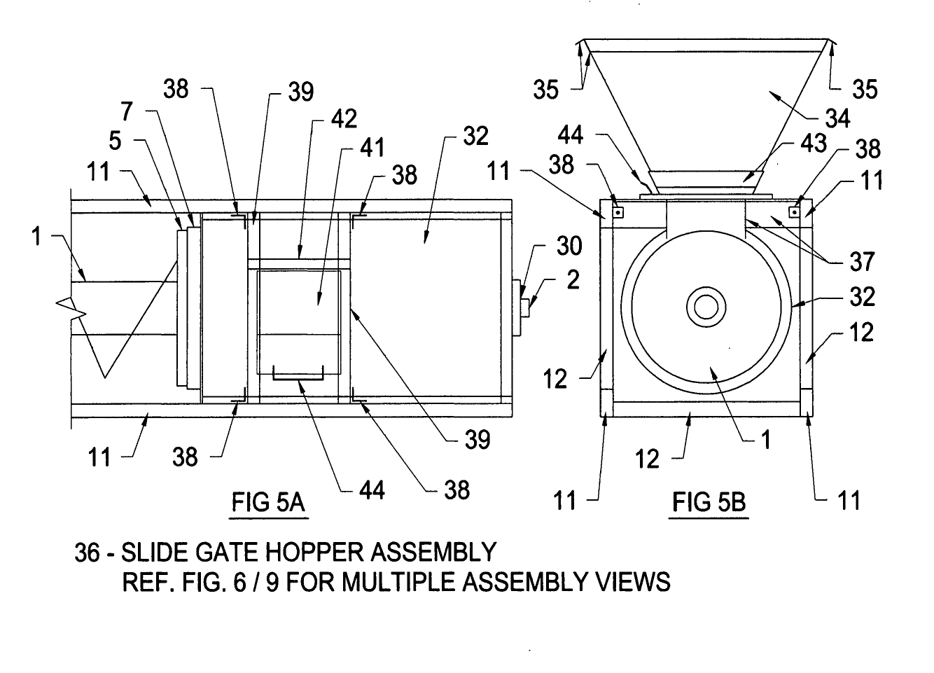

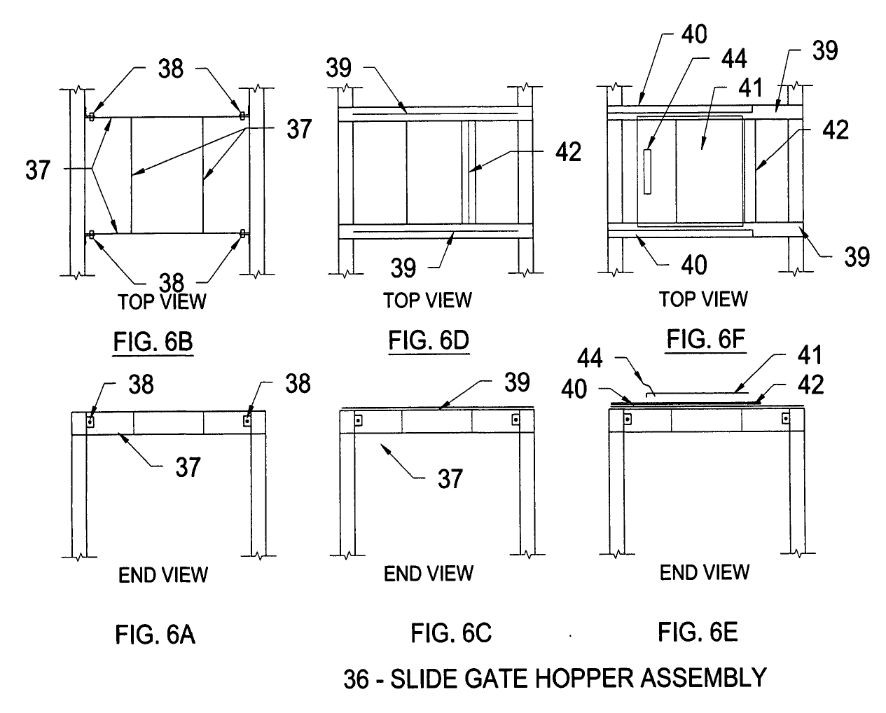

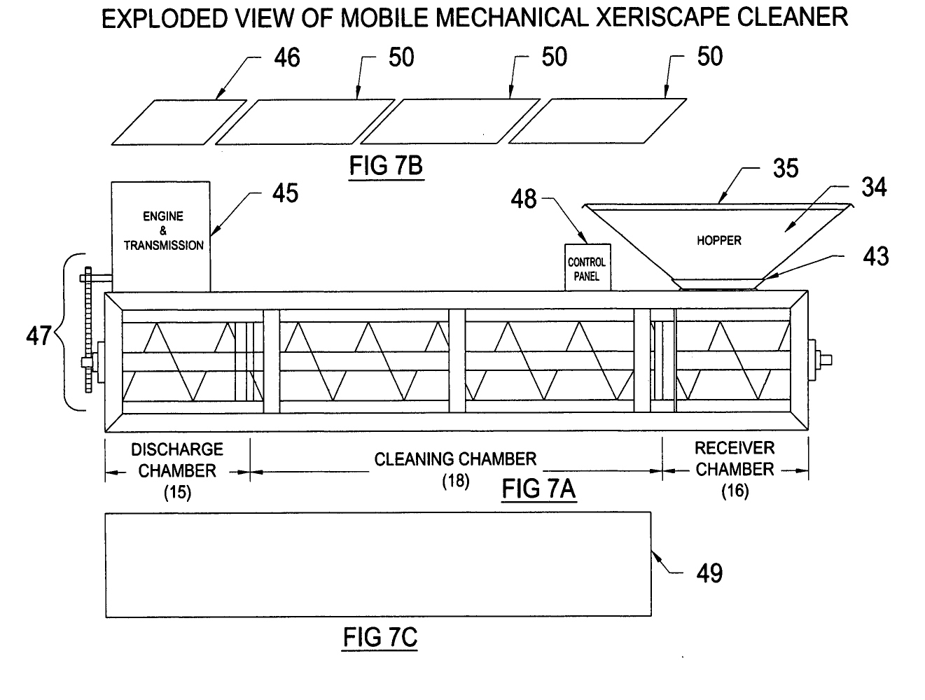

As can be amply seen from FIG. 5A, 5B and 6A through 6F of the mobile mechanical xeriscape gravel cleaner the frame is a welded metal frame 10 using rectangular tubing 11 with vertical and horizontal supports 12 spaced equally along its distance of sufficient length to accommodate auger assembly. A rectangular hopper 34 is constructed of flat metal, sides reinforced with angle iron supports 35, of sufficient top size to receive material to be cleaned from a device of the operators choosing and the bottom size to open over the entire rectangular cutout section of the cylindrical material in the receiving chamber. A box is constructed of four vertical flat metal bars 37 to support the slide gate hopper assembly 36 (FIG. 6A and 6B). At each outer corner of the box a vertical piece of angle iron 38 is welded to the welded metal frame 10 and bolted to the box to support the box placement. FIG. 6C and 6D demonstrate additional flat bars 39 are welded horizontally on center across the length of the aforementioned vertical flat metal bars 37 of the supporting box. FIG. 6E and 6F demonstrate additional, more narrow flat bars are welded to the aforementioned horizontal flat bars 39, flush with the outer edge to serve as the outer edge slide gate guide 40. A flat piece of metal, slightly thinner than the last flat bars applied, is welded across the back end of the existing box opening to serve as the slide gate stop 42. In FIG. 7A A receiver box 43 is assembled of flat metal welded at the corners at an angle consistent with the angle of the hopper 34. The box 43 is then welded to the top of the slide gate hopper assembly 36 FIG. 6A through 6F. The hopper 34 is bolted to top of receiver box 43. In FIG. 6E and 6F the slide gate 41 is a piece of flat metal with an attached handle 44, the dimension of which are determined by the opening of the slide gate guides 40 for the purpose of regulating the flow of material from the bottom of the hopper 34 to the receiving chamber 16.

As can be amply seen from the FIG. 7A, 7B and 7C of the mobile mechanical xeriscape gravel cleaner the auger 1 rotation is achieved by way of a variable speed external power drive 45 mounted on the fixed motor plate 46 bolted to the welded metal frame 10, connected to the auger by a chain and sprocket drive 47. The variable speed external power drive 45 is managed at the control panel 48 mounted on the welded metal frame 10. Side panels 49 of solid thin gauge metal are fastened to the welded metal frame 10 on the interior of the both horizontal surface. There are three cover plates 50 hinged and fastened to the top of the welded metal frame 10 for the purpose of inspection, maintenance and worker safety.

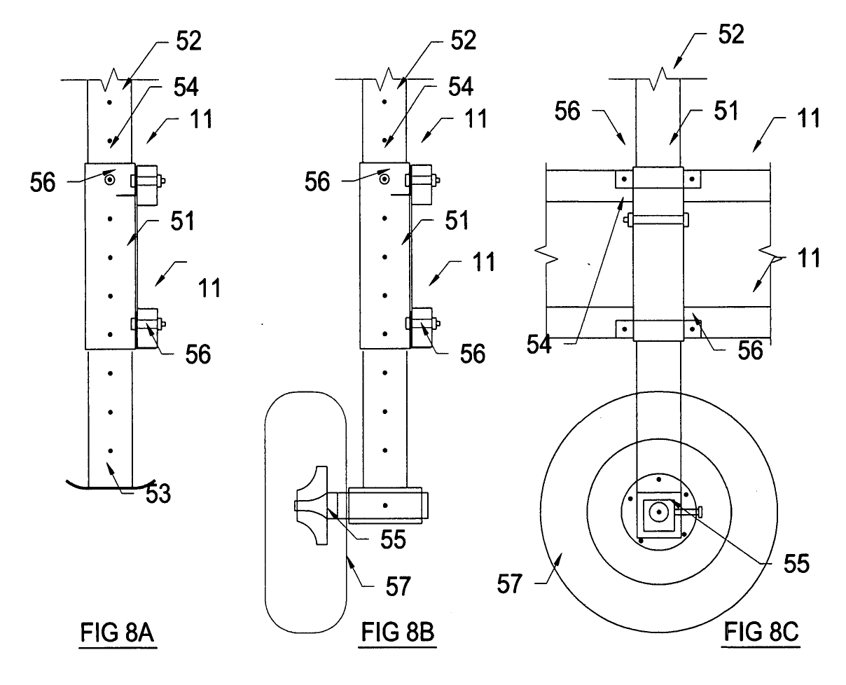

As can be amply seen from the FIG. 8A, 8B and 8C of the mobile mechanical xeriscape gravel cleaner at the receiving chamber end and mounted to the each side of the welded metal frame are adjustable independent support jacks to add stability and allow leveling of the device during operation. The adjustable independent support jacks are constructed from a length of square tubing 51, pre-drilled for slide adjustment. Two length of angle iron 56 are welded to the upper and lower edge of larger square tubing 51 for bolt mounting to the welded metal frame 10. A length of inner square tubing 52 of slightly smaller dimension, also pre-drilled for slide adjustment is inserted into the aforementioned larger square tubing 51. A bolt 54 suitable to fit through the pre-drilled holes in the square metal tubing 51 and 52 is used to secure the inner and outer square tubing 51 and 52 at adjustment height. A flat plate is welded to the bottom of the inner tube 52 with edges bent up to form a foot plate 53 for the adjustable independent support jack stand. The adjustable independent support jack stand is mounted on the receiving chamber end of the welded metal frame 10. The adjustable independent axle with wheel and floatation tire will be constructed as the adjustable independent support jack stand, however in place of a foot plate a standard spindle and hub 55 will be attached to the bottom of the inner tubing 52 and a flotation wheel/tire 57 assembly of appropriate size to facilitate mobility of the mobile mechanical xeriscape gravel cleaner will be attached to the aforementioned hub 55 with lug nuts. The angle iron 56 of the adjustable independent axle with wheel and floatation tire will be welded to the larger square metal tubing 51 and bolted to the rectangular tubing 11 of the welded metal frame 10 at sixty percent of the length of the welded metal frame 10 from the receiving chamber 16 end.

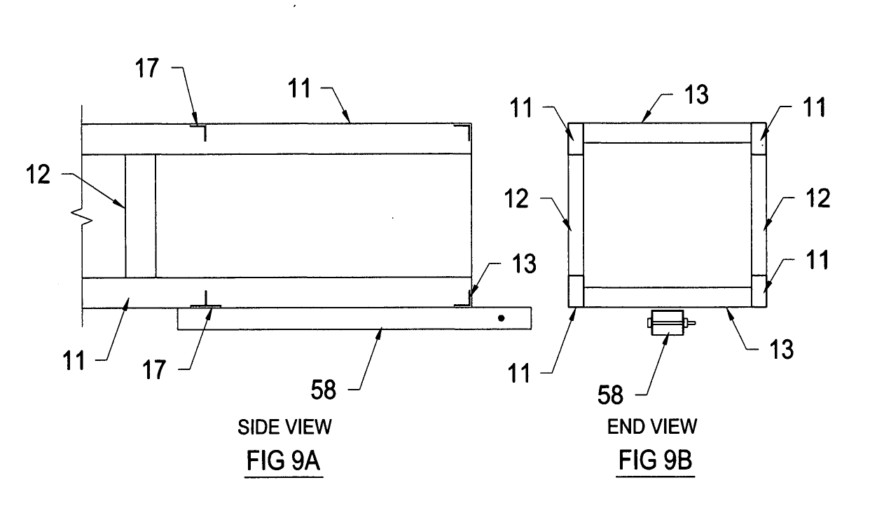

As can be amply seen from the FIG. 9A and 9B of the mobile mechanical xeriscape gravel cleaner a length of square tubing 58 is welded to the existing lower surface angle irons 13 and 17 on receiving chamber end of the mobile mechanical xeriscape gravel cleaner which will accept a common receiver hitch for the purpose of towing the mobile mechanical xeriscape gravel cleaner when desired.

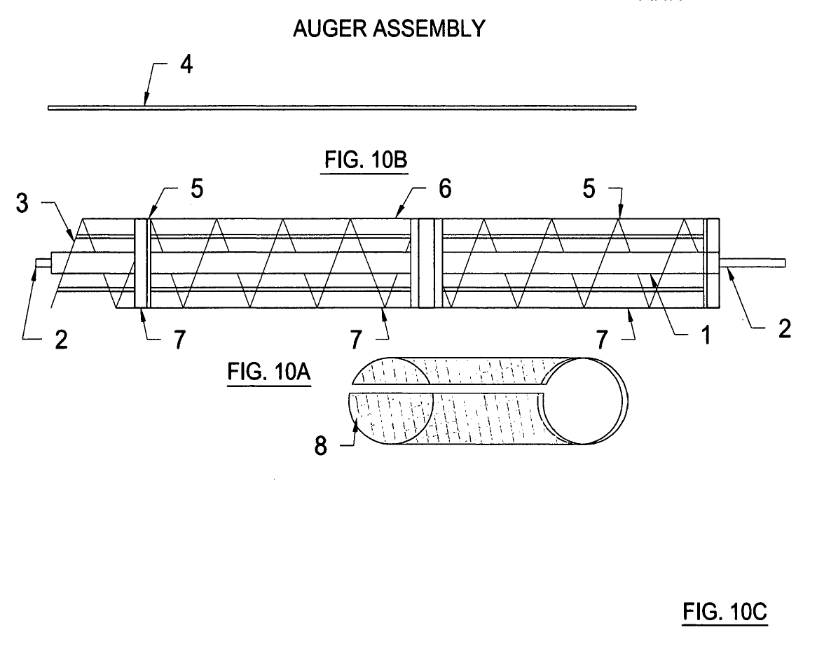

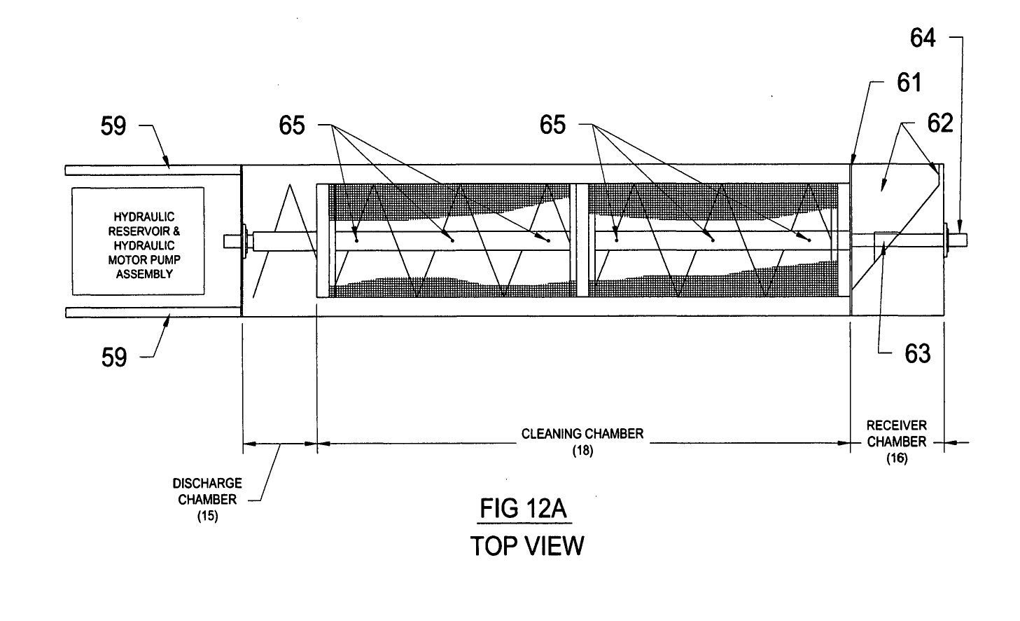

As can be amply seen from FIG. 10 A to E of the hydraulic design annotated sheet the clamping bands 9 have been removed and, as shown in FIG. 12, have been replaced with metal screws and shoulder washer 65 to secure the screen 8 to the support bars 4 and provide for easy removal/replacement to accommodate variable size of material to be cleaned.

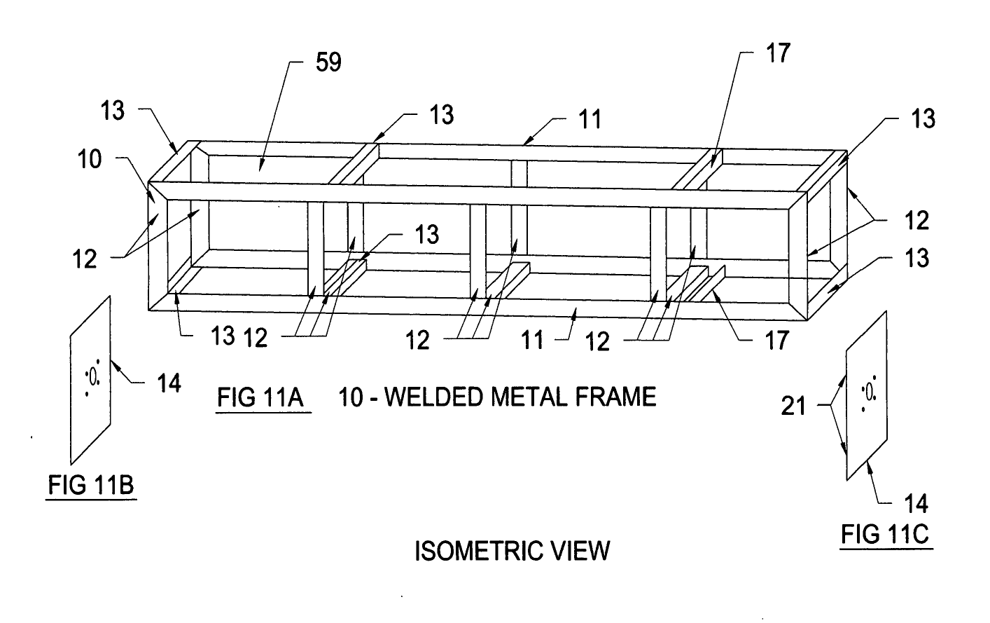

As can be amply seen from FIG. 11 A to C of the hydraulic design annotated sheet the angle iron 13 has been added to the support structure 12 to facilitate the mounting of the end plate 14 and provide for the redesigned extended welded metal frame 10 to create a hydraulic equipment space 59 and the split transition plate 19, the angle iron 38 have been removed.

As can be amply seen from FIG. 12A of the hydraulic design annotated sheet the welded metal frame 10 has been extended creating a hydraulic equipment space 59, metal screws with shoulder washers 65 have been added in place of clamping bands 9 and the receiving chamber 16 is redesigned with removal of the slide gate 41 and the cylindrical material 32 and extension of the auger shaft 64 addition of a one piece transition plate 61, a gravity flow shoot 62 with shaft guard 63.

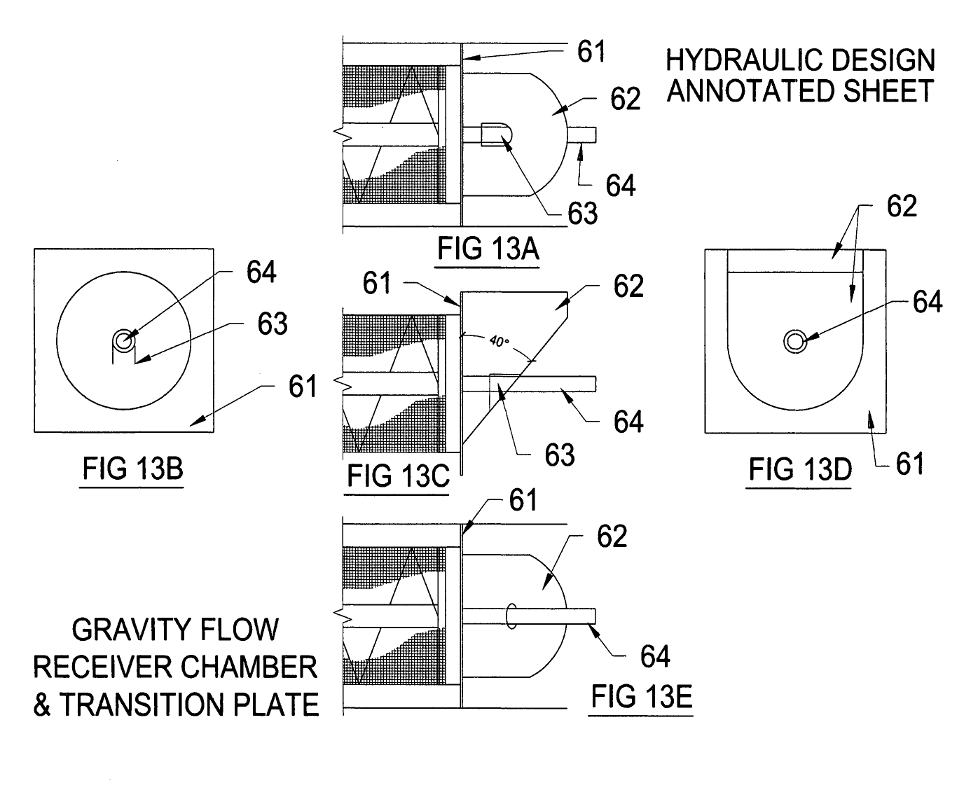

As can be amply see from FIGS. 13 A to 13 E of the hydraulic design annotated. sheet the shaft guard 63 is positioned over the shaft opening in the gravity flow shoot 62 and welded in place (FIG. 13 A and B and C). The gravity flow shoot 62 is preformed metal in a “U” shape with a 40 degree slope and a hole for passage of the extended auger shaft 64 which is welded to the one piece transition plate 61 from the top of the transition plate 61 down and around the outer edge of the opening in the transition plate 61.

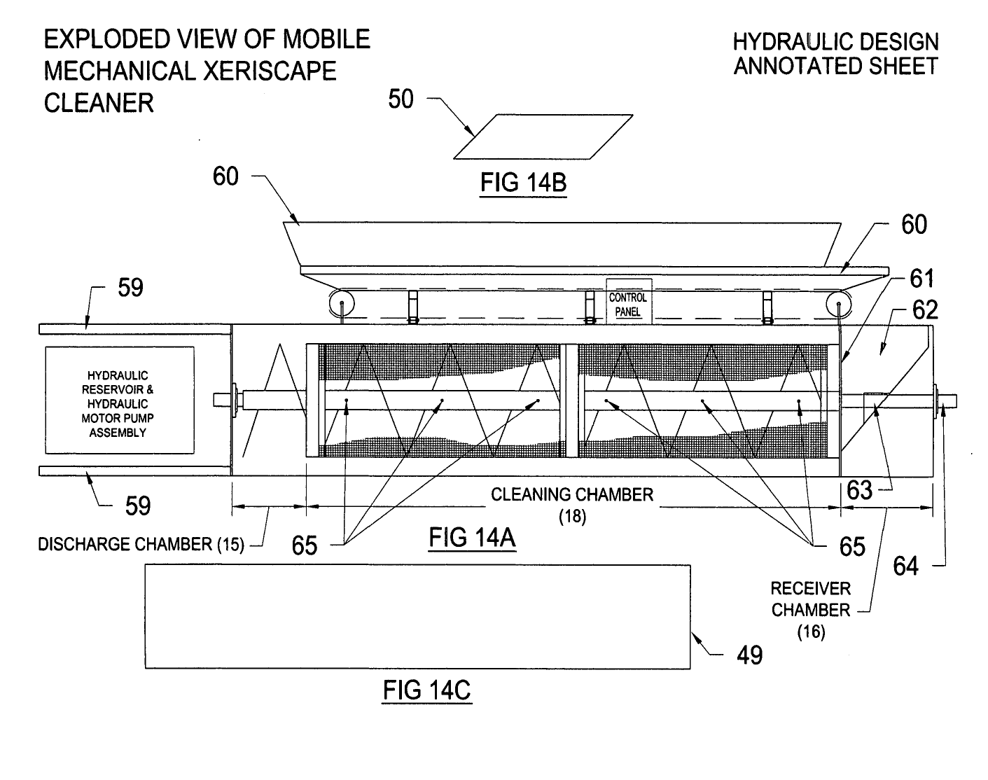

As can be amply seen from FIG. 14 A to C of the hydraulic design annotated sheet the hopper 34 and three of the four cover plates 50 are absent and replaced with the hydraulically powered drag chain hopper 60 which is bolted to the top surface of the welded metal frame 10 over the cleaning chamber 18 and in FIG. 14b the single cover plate 50 remains to be positioned over the discharge chamber 15. The hydraulically powered drag chain hopper is constructed of heavy gauge metal plate welded to contain the hydraulically powered drag chain 60, bolted to the welded metal frame 10 over the cleaning chamber 18 to contain soiled material as it is flow regulated into the receiving chamber 16.

1. A mobile mechanical xeriscape gravel cleaner comprising: a device constructed of a welded metal frame with independent wheels and axles, stabilization jacks, worker safety and access panels with endplates, and a single split transition plate; an external power device and control panel which provides control of a variable rotation speed and gravel flow rate based on volume of dirt and debris; a hopper with gravity feed and flow regulated with a slide gate; a receiving chamber; a cleaning chamber with a single flight or double flight auger; and a discharge chamber for collection and use of cleaned gravel.

2. A mobile mechanical xeriscape gravel cleaner according to claim 1: wherein said receiving chamber is a cylinder with inside diameter slightly greater than outside diameter of the auger and an inlet on top consistent with open hopper slide gate outflow, of a material that allows the gravel movement through the receiving chamber into the cleaning chamber with minimal friction.

3. A mobile mechanical xeriscape gravel cleaner according to claim 1: wherein said receiving chamber is separated from the cleaning chamber with the split transition plate to support the rear of the receiving chamber and direct the flow of xeriscaped gravel into cleaning chamber.

4. A mobile mechanical xeriscape gravel cleaner according to claim 1: wherein said auger is encapsulated in screen the length from the front of the cleaning chamber to the end of the cleaning chamber appropriate to the size of xeriscaped gravel being cleaned.

5. A mobile mechanical xeriscape gravel cleaner according to claim 1: wherein said discharge chamber is a auger area beyond the screened cleaning chamber which allows screened gravel to fall out of the mechanical cleaner.

6. A mobile mechanical xeriscape gravel cleaner according to claim 1: wherein said auger has support bars welded to it from the front of the cleaning chamber to the rear of the discharge chamber and screen support bands welded at the front, rear and middle of the cleaning chamber for the purpose of supporting/attaching screen and clamping bands.

7. A mobile mechanical xeriscape gravel cleaner according to claim 1: wherein said a screen is wrapped around the outside of a auger flighting, screen support bars, screen support bands and the overlapping edges, parallel to the auger and secured with clamping bands, allowing the operator to easily change screen as gravel size varies.

8. A mobile mechanical xeriscape gravel cleaner according to claim 1: wherein said auger is supported by end plates, lubricated bearings and adjustable roller wheel assemblies to facilitate rotation via the aforementioned external power device.

9. A mobile mechanical xeriscape gravel cleaner according to claim 1: wherein said receiving chamber, cleaning chamber and discharge chamber and end plates are supported by the welded metal frame consisting of bilateral upper and lower longitudinal supports and upper and lower lateral supports, roller wheel assemblies supporting the midpoint of the cleaning chamber of the auger assembly to support load and aid in rotation, and auger end plates attached to the welded metal frame.

10. A mobile mechanical xeriscape gravel cleaner according to claim 1: wherein a auger assembly is driven by the external power device attached to a plate mounted on top of the welded metal frame above the discharge chamber providing variable speed, forward and reverse drive appropriate to regulate flow of xeriscaped gravel through the auger assembly.

11. A mobile mechanical xeriscape gravel cleaner according to claim 1: wherein said hopper of sufficient dimension to receive xeriscape gravel from device of operator's choosing; the slide gate with external control handle mounted above the receiving chamber to control flow of gravel from the hopper to the receiving chamber.

12. A mobile mechanical xeriscape gravel cleaner according to claim 1: wherein the worker safety and access panels are attached by way of hinges to the superior surface of the welded metal frame over the cleaning and discharge chambers and side enclosure metal surfaces are fastened to the inner surface of the cleaning and discharge chambers of the welded metal frame.

13. A mobile mechanical xeriscape gravel cleaner according to claim 1: wherein a auger assembly is driven by an external power driven motor or engine, capable of providing power to the auger assembly component appropriate for variable speed rotation, forward and reverse with linkage to the control panel mounted on the welded metal frame.

14. A mobile mechanical xeriscape gravel cleaner according to claim 1: wherein said metal frame is leveled and supported prior to and during operation on four jack stands on foot plates mounted near each corner of the welded metal frame.

15. A mobile mechanical xeriscape gravel cleaner according to claim 1: wherein said mobile mechanical xeriscape gravel cleaner is, mounted about sixty percent distance from receiver chamber end of device, mounted on an adjustable, single, independent axle support with wheels and floatation tires for mobility.

16. A mobile mechanical xeriscape gravel cleaner according to claim 1: wherein a square tube of sufficient size to accommodate a standard receiver hitch is welded to the midline of the underside of the welded metal frame extended from the front end of the lower plate support angle to the split transition plate lower support angle.

17. An improved mobile mechanical xeriscape gravel cleaner comprising: an auger assembly encased in a welded metal frame which provides support and attachment points for all internal and external components of the Mobile Mechanical Xeriscape Gravel Cleaner; mobility is provided by an independent wheel/axle assembly and four jack stands for leveling and stabilization on uneven surfaces and said assemblies are mounted onto the welded metal frame; the welded metal frame is topped with hinged worker safety/access panels and encased laterally with metal side panels; the welded metal frame has removable end plates with lubricated bearings to support the auger assembly; a split transition plate, which is located at the rear of the receiving chamber before the cleaning chamber, directs the flow of gravel into the cleaning chamber.

18. A mobile mechanical xeriscape gravel cleaner according to claim 17, further comprising: an external power driven motor or engine; a hydraulic and/or gear; a chain and sprocket system at the rear of the welded metal frame utilizing a control panel mounted on the welded metal frame near the hopper to provide power to the mobile mechanical xeriscape gravel cleaner.

19. A mobile mechanical xeriscape gravel cleaner according to claim 18: the external power driven motor or engine, hydraulic and/or gear, chain and sprocket system will provide variable speed, forward and reverse rotation to the auger assembly.

20. A mobile mechanical xeriscape gravel cleaner according to claim 18: the hydraulic external power drive will additionally provide hydraulic activation of the leveling jack stands, hydraulic operation of a movable hopper to allow a lower loading position and hydraulic operation of the wheel/axle assembly to manage mobility of the entire cleaner device from the control panel located at the receiving chamber end of the mobile mechanical xeriscape gravel cleaner.

21. The hydraulic design of the mobile mechanical xeriscape gravel cleaner is comprised of: an extended welded metal frame, a redesign of the split transition plate and the receiving chamber and replacement of the hopper and slide gate with a hydraulically powered drag chain hopper.

22. The hydraulic design of the mobile mechanical xeriscape gravel cleaner according to claim 21, further comprising: an extended welded metal frame beyond the discharge chamber providing an area sufficient to accommodate a hydraulic reservoir with motor and hydraulic pump.

23. The hydraulic design of the mobile mechanical xeriscape gravel cleaner according to claim 21, further comprising: a one piece transition plate with a hole diameter eighty percent of the auger diameter to allow minimal separation of auger and transition plate to minimize spillage of gravel as it transitions to the cleaning chamber.

24. The hydraulic design of the mobile mechanical xeriscape gravel cleaner according to claim 21, further comprising: a hydraulically powered drag chain hopper mounted on top of the welded metal frame with attachment bolts for easy removal as needed creating a controlled flow of gravel to the receiving chamber.

25. The hydraulic design of the mobile mechanical xeriscape gravel cleaner according to claim 21, further comprising: the auger begins at the one piece transition plate between the receiving chamber and the cleaning chamber and the auger shaft extends from the one piece transition plate through the receiving chamber and the end plate to the mounted bearing.

26. The hydraulic design of the mobile mechanical xeriscape gravel cleaner according to claim 21, further comprising: a gravity flow shoot within the receiving chamber made of preformed metal in a “U” shape with an opening to accommodate passage of the auger shaft, with the opening shielded to prevent spillage through the opening, which is welded to the outer edge of the transition plate opening to allow gravel to flow from the drag chain hopper assembly into the gravity flow shoot and through the receiving chamber to the cleaning chamber.
